(19) United States
(12) Patent Application Publication
(10) Pub. No.: US 2022/0067930 A1
(43) Pub. Date: Mar. 3, 2022

(54) SYSTEMS AND METHODS FOR PREDICTING GROWTH OF A POPULATION OF ORGANISMS

(71) Applicant: XPERTSEA SOLUTIONS INC., Québec (CA)

(72) Inventors: Valérie ROBITAILLE, Shannon (CA); Cody ANDREWS, Shannon (CA); Samuel COUTURE BROCHU, Québec (CA); Lucas MARCOTTE-RICHARDSON, Stoneham-et-Tewkesbury (CA); Vincent MARCEAU, Québec (CA); Julien ROY, Québec (CA); Joey BOLDUC-GILBERT, Québec (CA); Louis-David COULOMBE, Québec (CA); Yaroslav BABICH, Québec (CA)

(21) Appl. No.: 17/415,049

(22) PCT Filed: Dec. 18, 2019
(86) PCT No.: PCT/CA2019/051847

§ 371 Date: Jun. 17, 2021

Related U.S. Application Data
(60) Provisional application No. 62/783,762, filed on Dec. 21, 2018.

(51) Int. Cl. G06T 7/00; A01K 29/00

(52) U.S. Cl. CPC G06T 7/0012; A01K 29/00

(57) ABSTRACT

There is described a system for predicting growth of a population of organisms. The system has: a container; a structure facing the container and having a camera with a field of view orientable towards a sample of said population of organisms, and being configured for acquiring an image of said sample at a moment in time; and a controller configured for: accessing said image; using a growth indication quantity determination engine and said accessed image, determining at least a value of the growth indication quantity being associated to the sample of said population; and using a growth prediction engine, and based on a previously determined value of the growth indication quantity at a prior moment in time and on the determined value of the growth indication quantity, determining at least a predicted value of said growth indication quantity for said population at least at a subsequent moment in time.

### FIELD

The improvements generally relate aquaculture and more specifically relate to systems and methods for monitoring and predicting growth of a population of organisms.

### BACKGROUND

Aquaculture involves cultivating populations of marine organisms (e.g., fish, shrimps, eggs, crustaceans, molluscs or aquatic plants) as they grow over time. Typically, the population of organisms are grown in a pond, a pool, an open sea cage or in any other suitable fenced area up until the organisms of the population are satisfactorily grown, after which they are removed from the fenced area and sold to a processing plant. Income associated with the selling of a population of organisms generally depends on the weight, the size and/or the volume of the organisms contained in the population. Accordingly, selling the population too early during the growth of the organisms can reduce income and thus impede profitability. Although experienced aquaculture farmers are used to estimating when a population of organisms is satisfactorily grown, there still remains room for improvement.

### SUMMARY

In accordance with one aspect, there is provided a system for predicting growth of a population of organisms, using at least a first value of a growth indicator quantity being associated to a first sample of said population at a first moment in time, the system comprising: a container; a structure facing the container and having a camera with a field of view orientable towards a second sample of said population of organisms, and being configured for acquiring an image of said second sample at a second moment in time; and a controller having a memory and a processor configured to perform the steps of: accessing said image; using a growth indication quantity determination engine being stored on said memory and said accessed image, determining at least a second value of the growth indication quantity being associated to the second sample of said population; and using a growth prediction engine, and based on at least the first and second values of the growth indication quantity, determining at least a predicted value of said growth indication quantity for said population at least at a subsequent moment in time.

In accordance with another aspect, there is provided a method for predicting growth of a population of organisms, the method comprising: receiving a first sample of said population of organisms into a container at a first moment in time; imaging said first sample of said population to obtain a first image; using a growth indication quantity determination engine and said first image, determining at least a first value of the growth indication quantity being associated to the first sample of said population; receiving a second sample of said population of organisms into the container at a subsequent, second moment in time; imaging said second sample of said population to obtain a second image; using the growth indication quantity determination engine and said second image, determining at least a second value of the growth indication quantity being associated to the second sample of said population; and using a growth prediction engine, and based on at least the first and second values of the growth indication quantity, determining at least a predicted value of said growth indication quantity for said population at least at a subsequent moment in time.

In accordance with another aspect, there is provided a method for predicting growth of a population of organisms, the method comprising: receiving a first sample of said population of organisms into a container at a first moment in time; imaging said first sample of said population to obtain a first image; using a growth indication quantity determination engine and said first image, determining at least a first value of the growth indication quantity being associated to the first sample of said population; and using a growth prediction engine, accessing prior experimental data pertaining to said organisms, and determining at least a predicted value of said growth indication quantity for said population at least at a subsequent moment in time based on said prior experimental data, said first value of the growth indication quantity and on said first moment in time.

In accordance with another aspect, there is provided a method for predicting growth of a population of organisms, the method comprising: receiving a first image representing a first sample of said population of organisms into a container at a first moment in time; using a growth indication quantity determination engine and said first image, determining at least a first value of the growth indication quantity being associated to the first sample of said population; receiving a second image representing a second sample of said population of organisms into the container at a subsequent, second moment in time; using the growth indication quantity determination engine and said second image, determining at least a second value of the growth indication quantity being associated to the second sample of said population; and using a growth prediction engine, and based on at least the first and second values of the growth indication quantity, determining at least a predicted value of said growth indication quantity for said population at least at a subsequent moment in time.

In accordance with another aspect, there is provided a method for predicting growth of a population of organisms, with at least a first value of a growth indication quantity being associated to a first sample of said population, the method comprising: receiving a second image representing a second sample of said population of organisms into the container at a subsequent, second moment in time; using the growth indication quantity determination engine and said second image, determining at least a second value of the growth indication quantity being associated to the second sample of said population; and using a growth prediction engine, and based on at least the first and second values of the growth indication quantity, determining at least a predicted value of said growth indication quantity for said population at least at a subsequent moment in time.

In accordance with another aspect, there is provided a method for predicting growth of a population of organisms, the method comprising: receiving at least a first value of a growth indication quantity being associated to a first sample of said population; receiving at least a second value of the growth indication quantity being associated to the second sample of said population; and using a growth prediction engine, and based on at least the first and second values of the growth indication quantity, determining at least a predicted value of said growth indication quantity for said population at least at a subsequent moment in time.

Many further features and combinations thereof concerning the present improvements will appear to those skilled in the art following a reading of the instant disclosure.

### DESCRIPTION OF THE FIGURES

In the figures,

FIG. 1A is a cross-sectional, transversal view taken along a longitudinal axis of an example of a system for predicting growth of a population of organisms, in accordance with an embodiment;

FIG. 1B is a cross-sectional, top view taken along section 1B-1B of the system of FIG. 1A, in accordance with an embodiment;

FIG. 1C is an example of an image acquired by the system of FIG. 1A, in accordance with an embodiment;

FIG. 2 is a schematic view of an example of a computing device of a controller of the system of FIG. 1, in accordance with an embodiment;

FIG. 3 is a schematic view of an example of a software application of the controller of FIG. 1 being configured to perform a method of predicting growth of a population of organisms, in accordance with an embodiment;

FIG. 4 is a graph showing values of a growth indication quantity at different moments in time, with a nonlinear growth curve showing predicted values of the growth indication quantity, in accordance with an embodiment;

FIG. 5 is a histogram showing a distribution of values of the growth indication quantity at a given moment in time, with a shape being fitted to the distribution of values, in accordance with an embodiment;

FIG. 6 is a schematic view of another example of a system for predicting growth of a population of organisms, integrated to a mobile electronic device, in accordance with an embodiment; and

FIG. 7 is a diagram illustrating an exemplary system involving the system of FIG. 6, in accordance with an embodiment.

### DETAILED DESCRIPTION

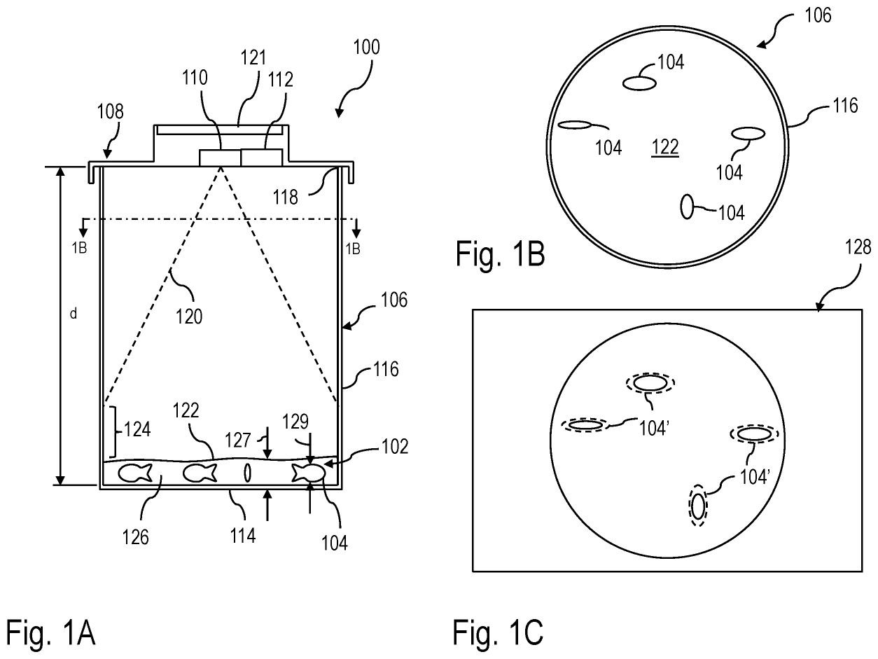

FIGS. 1A-B show an example of a system 100 for predicting growth of a population of organisms. The organisms can include marine organisms such as shrimps, fish, eggs, crustaceans, molluscs, plankton, aquatic plants and/or algae, and can include insects in some specific embodiments.

As depicted, the system 100 has a container 106 which in this case receives a sample 102 of organisms 104. The sample 102 can originate from sampling a fenced area, such as a pond, a pool, an open sea cage and the like, containing the population of organisms.

In this specific example, the system 100 has a structure 108 facing the container 106 and one (or more) camera(s) 110 mounted to the structure 108 in wired or wireless communication with a controller 112. In some embodiments, the structure 108 is directly mounted to the container 106. In some other embodiments, the structure 108 may face the container 106 while not being necessarily mounted thereto. In the illustrated example, the container 106 can be referred to as a closed container due to its closed bottom 114 from which is extending a contour wall 116.

More specifically, in this embodiment, the structure 108 is used to maintain the camera 110 at a given distance d from the closed bottom 114 of the container 106. As illustrated in FIG. 1A, the structure 108 is provided in the form of a lid 109, which is removably connected to an upper end 118 of the contour wall 116, opposite the closed bottom 114.

In this embodiment, the container 106 and the structure 108 are made light hermetic to prevent light from entering the container 106 to avoid undesirable interference between ambient light and the system 100, for instance.

Moreover, still in this specific embodiment, an inner face 115 of the closed bottom 114 and an inner face 117 of the contour wall 116 are light reflective. In this way, a light emitting device 111 of the system 100 can be adapted to provide satisfactory lighting conditions during image acquisition by the camera 110.

As shown, in this example, the camera 110 is positioned so that, when the container 106 receives the sample 102 of organisms 104, the camera 110 can image the sample 102, or a portion thereof, for further analysis by the controller 112.

In other words, the camera 110 has a field of view 120 which is oriented towards the sample 102. As depicted, the field of view 120 of the system 100 shown in FIG. 1A encompasses an entirety of a top surface 122 of the sample 102 as well as a portion 124 of the contour wall 116, as better seen in an image 128 acquired by the camera 110 such as shown in FIG. 1C. In alternate embodiments, the field of view 120 can be limited to a given portion of the sample 102.

As will be described in detail below, a first sample of the population of organisms is received into the container 106 at a first moment in time, after which the first sample can be imaged to obtain a first image. Using a growth indication quantity determination engine, the controller 112 is configured to determine at least a first value of a growth indication quantity being associated to the first sample of the population. At a subsequent, second moment in time, e.g., when it is assumed that the organisms of the population have grown since the first moment in time, a second sample of the population of organisms is received into the container 106. The second sample can then be imaged to obtain a second image. Similarly, the controller 112 is configured to determine at least a second value of the growth indication quantity being associated to the second sample of the population using the growth indication quantity determination engine. Based on the first and second values of the growth indication quantity, a growth prediction engine of the controller 112 is configured to determine at least a predicted value of the growth indication quantity for the population at least at a subsequent moment in time.

At later moments in time, other samples of the population can be received in the container 106 for imaging and growth indication quantity determination purposes. In such circumstances, the growth prediction engine can be configured to, based on the values of the growth indication quantity for these other samples, determine values of the growth indication quantity at least at a subsequent moment in time. It is envisaged that by doing so, the predicted values of the growth indication quantity can be more accurate as they are based on a greater number of data points.

As such, the so-determined predicted value(s) of the growth indication quantity can enable aquaculture farmer(s) to make informed decision concerning whether the population is ready to be harvested.

In further embodiments, the predicted values of the growth indication quantity can be used to determine whether the population should be harvested and sold now or wait to a later moment in time, in order to maximize profits based on the market demand. In these embodiments, market prices being function of the species of the organisms can be involved and updated as function of the market or of the time of the year for instance. Other economical parameters can be used in the profitability optimization such as market price for organisms in specific weight ranges, fixed plant operation costs, weekly plant operation costs, feed costs and the like.

It is noted that the growth indication quantity can be any quantity which varies with growth of a given species of organisms. For instance, the growth indication quantity can be biomass, a body weight, a body size, a body volume and the like in some embodiments. The growth indication quantity can be an average, a median, a standard deviation, a coefficient of variation, or any aggregated metric of individual values in the population or can be a distribution function representative of individual values in the population. The growth indication quantity can be a colour, a shape, a grade and/or a stage (e.g., representative of molting) associated to the organisms in some other embodiments.

In embodiments where the growth indication quantity is a body weight, the first value can be indicative of a distribution of individual values of body weight associated to the plurality of organisms present in the sample. Alternately, the first value can be indicative of an average value of the individual values of body weight associated to the plurality of organisms present in the sample.

In embodiments where the growth indication quantity is related to the body weight of the organisms, the growth prediction engine can be configured to predict a growth indication quantity that can be indicative of a distribution of individual values of body weight associated to the organisms of the population. For instance, the predicted value can be a distribution function describing the proportion of organisms in the population within a given body weight range. Alternately, the predicted value can be indicative of an average value of the individual values of body weight of the organisms in the population.

Published PCT applications WO 2012/083461 and WO 2016/004527 describe examples of systems which can be used to determine biomass, size, volume, shape and/or colour, the contents of which are incorporated herein by reference. An example of a scale which can be used to determine value(s) of body weight associated to organisms is described in Published PCT application WO 2019/210421, the content of which is incorporated herein by reference.

In this specific embodiment, the system 100 includes a visual indicator 121 which can be operable to visual indicator the predicted value(s) of the growth indication quantity upon determination by the controller 112. However, in other embodiments, the visual indicator may be remotely located relative to the system 100. For instance, the visual indicator may be provided in the form of a computer application, a web page, a web application, or a mobile application accessible through a network such as the Internet.

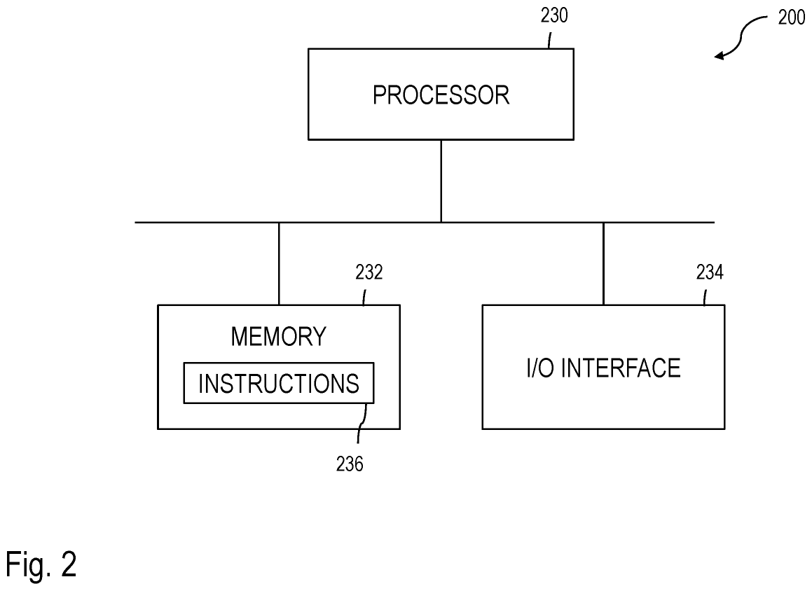

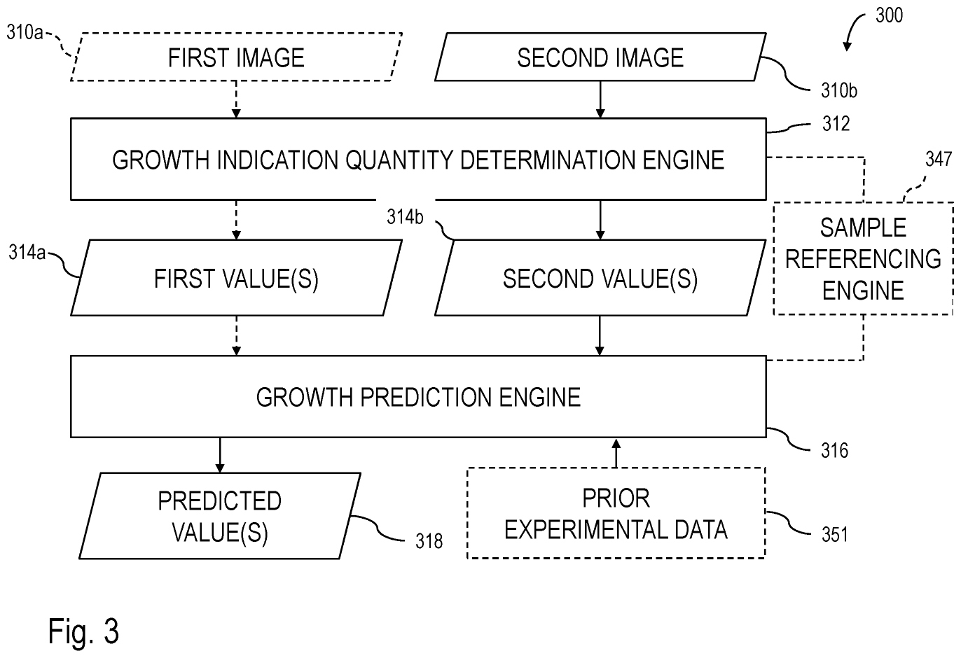

The controller 112 can be provided as a combination of hardware and software components. The hardware components can be implemented in the form of a computing device 200, an example of which is described with reference to FIG. 2. Moreover, the software components of the controller 112 can be implemented in the form of a software application 300, an example of which is described with reference to FIG. 3.

More specifically, and referring now to FIG. 2, the computing device 200 can have a processor 230, a memory 232, and I/O interface 234. Instructions 236 for predicting growth of a population of organisms can be stored on the memory 232 and accessible by the processor 230.

The processor 230 can be, for example, a general-purpose microprocessor or microcontroller, a digital signal processing (DSP) processor, an integrated circuit, a field programmable gate array (FPGA), a reconfigurable processor, a programmable read-only memory (PROM), or any combination thereof.

The memory 232 can include a suitable combination of any type of computer-readable memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 234 enables the computing device 200 to interconnect with one or more input devices, such as the camera 110, or with one or more output devices such as the visual indicator 121.

Each I/O interface 234 enables the controller 112 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

As can be understood, the processor 230, the memory 232, and other components of the system 100 requiring electrical power can be powered using a power supply. In one embodiment, the power supply is a standalone power supply, such as a battery or a solar panel, to offer greater mobility to the system 100 than by the use of a power cord, for instance.

Referring now to FIG. 3, the software application 300 is stored on the memory 232 and accessible by the processor 230 of the computing device 200. As can be understood, the software application 300 can be executed by the controller 112 and is described with reference to the system 100 of FIG. 1A for ease of reading.

As shown, the software application 300 is configured to access a first image 310a representing a first sample of organisms of the population at a first moment in time. The first image 310a can be accessed directly from the camera 110, and alternately or additionally, be accessed from the memory 232 where the image 310a has been previously stored after its acquisition by the camera 110.

As depicted, the software application 300 includes a growth indication quantity determination engine 312 which is stored on the memory 232 and executable by the processor 230 in this example.

More specifically, the software application 300 is configured to perform the step of, using the growth indication quantity determination engine 312, determining at least a first value (hereinafter “the first value 314a”) of a growth indication quantity being associated to the first sample of the population using the first image 310a.

In some embodiments, the first value 314a is provided in the form of an average value of a plurality of individual values associated to respective organisms of the first sample as shown in the first image 310a. Alternately or additionally, the first value 314a is provided in the form of a distribution of individual values associated to respective organisms of the first sample as shown in the first image 310a.

In such embodiments, the growth indication quantity determination engine 312 is configured to detect one or more organism representations in the first image 310a and to generate detection data concerning the detected organism representations. Once detected, the growth indication quantity determination engine 312 is configured to determine the individual values of the growth indication quantity associated to each of the detected organism representations based on the detection data.

Depending on the embodiment, the detection data can include one or more annotated images showing the position of the detected organism representations, one or more cropped images each showing a respective one of the detected organism representations, coordinates of the detection organism representations, a combination thereof, or any other suitable information concerning the detected organism representations in the first image 310a.

As illustrated, the software application 300 is also configured to access a second image 310b representing a second sample of organisms of the population at a subsequent, second moment in time. The second image 310b can be accessed directly from the camera 110, and alternately or additionally, be accessed from the memory 232 where the second image 310b has been previously stored after its acquisition by the camera 110.

Similarly to as described above, the software application 300 is configured to perform the step of, using the growth indication quantity determination engine 312, determining at least a second value (hereinafter “the second value 314b”) of the growth indication quantity being associated to the second sample of the population using the second image 310b.

As can be understood, as the first and second images 310a and 310b are taken are different, temporally spaced-apart moments in time, the organisms of the population may have grown between the acquisitions of the first and second images 310a and 310b. In such a case, it can be expected that the second value 314b be larger than the first value 314a for instance.

The time between the acquisition of the first image 310a and the acquisition of the second image 310b can be as short as a few seconds and as long as a few days or weeks. Preferably, the frequency at which the population of organisms is sampled and measured ranges between one per day and a couple of times per month.

As can be understood, the software application 300 needs not to determine both the first value 314a and the second value 314b. For instance, in some embodiments, the first value 314a and second value 314b are determined using different but similar systems 100. In some other embodiments, the first value 314a is received from a network or a remote memory where it has been stored for a given period of time. The first value 314a need not to be determined by a growth indication quantity determination engine either. For instance, in alternate embodiments, the growth indication quantity of the first sample is determined by visual inspection, inputted via a user interface, and then stored onto a memory which will be later accessible to the software application 300 for computational purposes.

The software application 300 is further configured to perform the step of, using a growth prediction engine 316, determining at least a predicted value 318 of the growth indication quantity for the population at least at a subsequent moment in time based on the first and second values 314a and 314b.

In some embodiments, the software application 300 can be configured to output a single predicted value 318 of the growth indication quantity at a predetermined subsequent period of time, e.g., one week, two weeks or one month later. However, in some other embodiments, it was found convenient to configure the growth prediction engine 316 to determine a plurality of predicted values 318 of the growth indication quantity for a plurality of subsequent moments in time. These predicted values 318 can be provided in the form of a continuous function varying as a function of time in some alternate embodiments. In any case, it can be preferred to determine the predicted values 318 for about 1 to 4 weeks after the last value measurement.

It can be appreciated that the predicted value(s) of the growth indication quantity determined by growth prediction engine can increase in accuracy with an increasing number of value(s) of the growth indication quantity. In other words, the accuracy of the growth prediction engine increases with the number of times that the population of organisms is tested over time to determine its corresponding value of the growth indication quantity. Accordingly, while the above-described embodiment describes the first and second values 314a and 314b, it is envisaged that a plurality of such value measurements can preferably be made and used in the determination of the predicted value(s) of the growth indication quantity. Additionally, as new values of the growth indication quantity are measured, the growth prediction engine can calculate new predicted values of the growth indication quantity taking into account the new measurements.

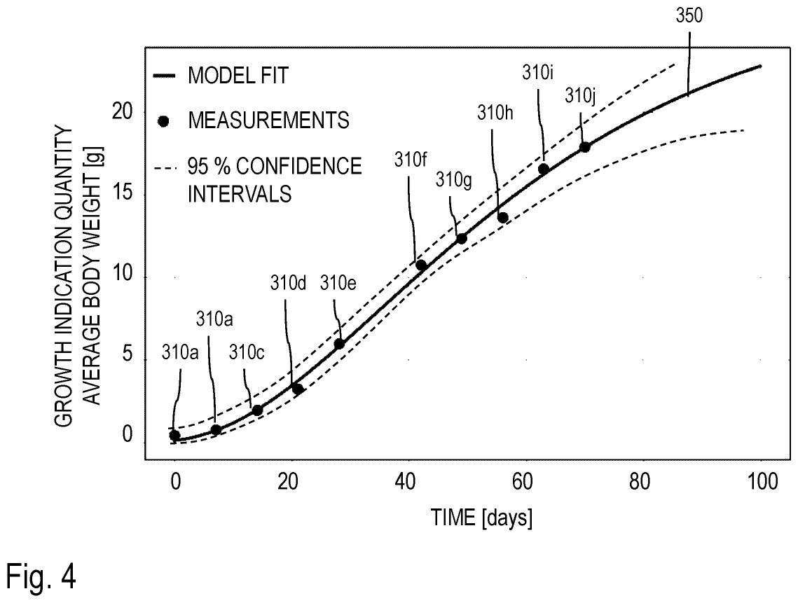

FIG. 4 is a graph of a growth indication quantity, in this case average body weight, as a function of time expressed in term of days. Data points being indicative of the first value 310a, the second value 310b and a plurality of other values 310c through 310j, and the moment in time at which they have been measured, are shown. As depicted, in this specific embodiment, the predicted values 318 are provided in the form of a curve 350 fitting the data points.

In some embodiments, in addition to the predicted values of the growth indication quantity, the growth prediction engine can also be configured to predict a confidence interval for the predicted values of the growth indication quantity. The confidence interval can be indicative of the certainty (or uncertainty) of the growth prediction engine on the predicted values, for instance an interval in which it is probable at 95% that the predicted values might lay. Examples of such confidence intervals are shown in dashed lines in FIG. 4 for predicted values of the average body weight. As depicted, these confidence intervals can act as boundaries within which the predicted values of the average body weight might lay

The computing device 200 and the software application 300 described above are meant to be examples only. Other suitable embodiments of the controller 112 can also be provided, as it will be apparent to the skilled reader. In alternate embodiments, the controller 112 need not to be mounted to the structure 108, or to the lid 109, of the system 100. In these embodiments, the controller 112 can be remotely located relative to the system 100 via a network such as the Internet for instance.

For instance, in some other embodiments, the engines 312 and 316 can be trained using supervised learning. Supervised machine learning engines can be based on Artificial Neural Networks (ANN), Support Vector Machines (SVM), capsule-based networks, Linear Discriminant Analysis (LDA), classification tree, a combination thereof, and any other suitable supervised machine learning engine. However, as can be understood, in some other embodiments, it is intended that the engines 312 and 316 can be trained using unsupervised learning. For instance, unsupervised clustering algorithms can be used. Two exemplary methods for improving classifier performance include boosting and bagging which involve using several classifiers together to “vote” for a final decision. Combination rules can include voting, decision trees, and linear and nonlinear combinations of classifier outputs. These approaches can also provide the ability to control the tradeoff between precision and accuracy through changes in weights or thresholds. These methods can lend themselves to extension to large numbers of localized features. In any case, some of these engines may require human interaction during training, or to initiate the engine, however human interaction may not be required while the engine is being carried out, e.g., during analysis of an accessed image. See Nasrabadi, Nasser M. “Pattern recognition and machine learning.” Journal of electronic imaging 16.4 (2007): 049901 for further detail concerning such trained engines.

### EXAMPLE 1

In this example, the growth prediction engine 316 assumes a series of N values of the distribution of individual values of the body weight {wₖ}ᵢ, with k=1, . . . , Mᵢ, associated to Mᵢ organisms present in a respective sample of the population and measured at moment in time tᵢ, with i=1, . . . , N indicating the temporally spaced-apart moments in time tᵢ at which the values were obtained using the system 100 described above with reference to FIG. 1. From the individual values of the body weight {wₖ}ᵢ, the growth prediction engine 316 is configured to determine the predicted values w(t) of the growth indication quantity of the population, and its weight distribution function, denoted ƒ(w, t), at later moments in time t>t_{N}.

As will be described below, the growth prediction engine 316 is configured to determine the predicted values 318 of the growth indication quantity based on an expected asymptotic size L_{∞} and on a rate of change of the values of the size varying linearly when approaching the asymptotic size L_{∞}. In this example, the rate of change can be given by:

$$\frac{dL ( t )}{dt} = r [ {L}_{∞} - L ( t ) ] . \qquad ( 1 )$$

as per Von Bertalanffy nonlinear growth model. Integration of equation (1) with respect to time can yield:

L(t)=[L_{∞}−L₀ exp(−r(t−t₀))], with L(t₀)=L₀. (2)

In this embodiment, the growth indication quantity is the body weight. However, in order to use equation (2), the body weight w of an organism can be correlated to its size L by a relationship of the form:

w∝L^{a}, (3)

where a is a constant for a given species of organisms, with a value usually close to 3 which correlates how the body weight of an organism change as a function of its size. The value of the constant a can be determined empirically for the species of the population. For instance, to determine the constant a, one may perform several body weight and size measurements on different organisms of the species of interest. Accordingly, it can be assumed that the evolution of the body weight w of an organism can be determined using a relation equivalent to the following equation:

w(t)=[w_{∞}−w₀ exp(−r(t−t₀))]^{a}, with w(t₀)=w₀. (4)

At moment in time tᵢ, the individual values of the body weight {wₖ}ᵢ can be used to estimate the average value of the body weight w̅ of the organisms for the population using:

$$\hat{{\overline{w}}_{ι}} = \frac{1}{{M}_{i}} {\sum }_{k = 1}^{{M}_{i}} {w}_{k , i} . \qquad ( 5 )$$

In this example, the growth prediction engine 316 assumes that the time evolution of the average weight w̅(t) of the organisms of the population can be described by a modified Von Bertalanffy growth model:

w̅(t)=[w̅_̅{̅∞̅}̅−w̅₀̅(exp(−r(t−t₀))]^{a}, with w̅(t₀)=w̅₀̅. (6)

The growth prediction engine 316 further assumes that the following parameters {t₀, w̅₀̅, w̅_̅{̅∞̅}̅} are constant values for each population. Accordingly, these parameters can depend on the specific environmental conditions in which the population is cultivated. In order to determine those parameters, the growth prediction engine 316 can solve the nonlinear least squares optimization problem described by:

$${min}_{{t}_{0} , \overline{{w}_{0}} , \overline{{w}_{∞}}} \frac{1}{2} {\sum }_{i = 1}^{N} {[ - \overline{w} ( {t}_{i} ; {t}_{0} , \overline{{w}_{0}} , \overline{{w}_{∞}} ) ]}^{2} . \qquad ( 7 )$$

where w̅(tᵢ; t₀, w̅₀̅, w̅_̅{̅∞̅}̅) can be given by equation (6).

Still referring to FIG. 4, the curve 350 embodies a solution of the equation (7) as determined by the growth prediction engine 316. Accordingly, assuming that the growth of the population of interest is described by such a model, the growth prediction engine 316 can determine predicted values of the growth indication quantity for the population at any moment in time t>t_{N}. As new values are measured over time, the growth prediction engine 316 can perform the optimization described above and determine better estimates of the parameters (t₀, w̅₀̅, w̅_̅{̅∞̅}̅).

While a modified version of the Von Bertalanffy nonlinear growth model was used in this example, it is understood that other nonlinear growth models could be used. For example, it could be determined by someone skilled in the art that another nonlinear growth model might prove suitable for a particular species of organism.

### EXAMPLE 2

In another example, the growth prediction engine 316 is configured to determine predicted values of the weight distribution function of the organisms of the population. To do so, the growth prediction engine 316 uses the most recent values of the body weight {wₖ}_{N} at moment in time t_{N}. More specifically, the growth prediction engine 316 assumes that the values of the body weight {wₖ}_{N} corresponds to a set of univariate independent and identically distributed samples drawn from a common weight density function ƒ(w, t_{N}). In this example, the growth prediction engine 316 determines a shape of the weight density function ƒ(w, t_{N}) by calculating its kernel density estimator [symbol] (w):

$$( 8 )$$

where Kₕ(w) is a kernel function of bandwidth h. In this example, the growth prediction engine 316 uses the Gaussian function as the kernel, with

$${K}_{h} ( w ) = exp ( - \frac{{w}^{2}}{2 {h}^{2}} ) .$$

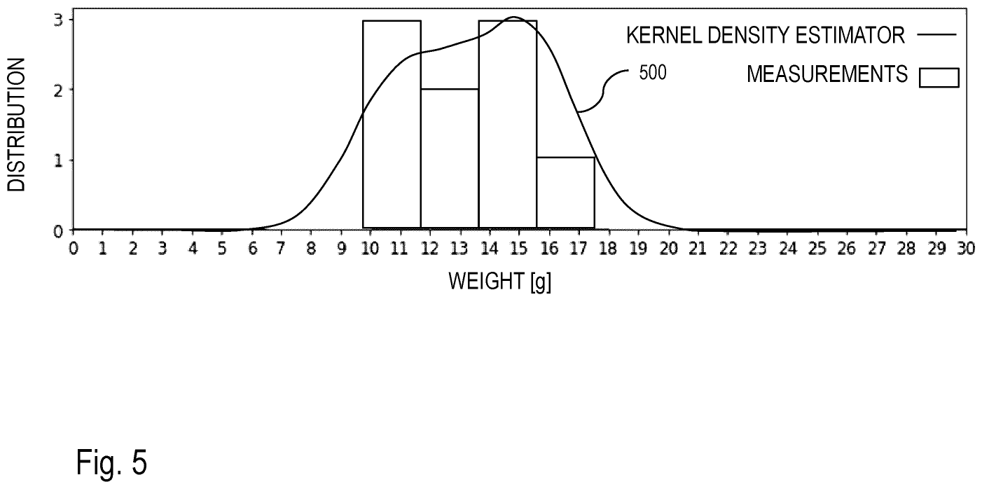

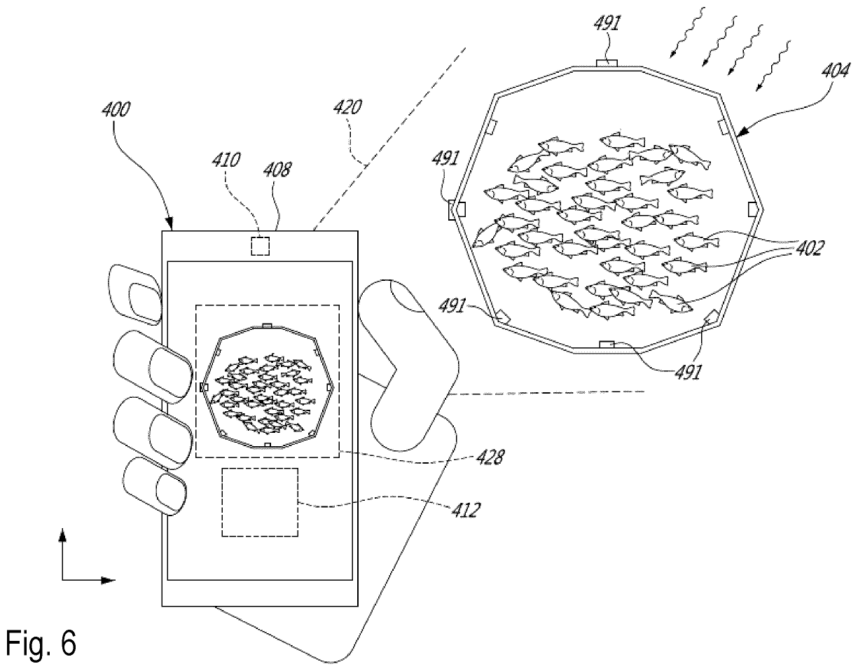

Other kernels such as the Tophat kernel or the Epanechnikov kernel could have alternately been used as well. An example of the kernel density estimation of [symbol] (w, t) is shown at 500 in FIG. 5.

To determine the weight distribution function at a given moment in time t>t_{N}, the growth prediction engine 316 first determines a predicted value of the average body weight w̅(t) using equation (6) with the parameters {t₀, w̅₀̅, w̅_̅{̅∞̅}̅} obtained by solving (7). Then, the growth prediction engine 316 can determine the kernel density estimator at time t_{N}, [symbol] (w), using equation (8). Under the assumption that each organism of the population can grow by the same fraction over the same period of time, the growth prediction engine 316 can determine a predicted value of the weight distribution function at moment in time t>t_{N} by shifting the kernel density estimator [symbol] (w) by a scaling factor γ, i.e. ƒ(w, t)= [symbol] (γw), where the scaling factor can be given by:

γ=w̅_̅{̅N̅}̅/w̅(t). (9)

It is understood that instead of using only the most recent values of the individual body weights distribution to determine the shape of ƒ(w, t), previous values of the individual body weights distribution can alternatively or additionally be taken into account to get a more accurate estimate of the predicted weight distribution function. Moreover, as new values are measured over time, the growth prediction engine can perform one or more iterations of the calculation and determine updated estimates for ƒ(w, t).

### EXAMPLE 3

In another example, the growth prediction engine can be configured to operate using the principles of Bayesian statistics. Bayesian statistics is a very powerful and general framework that allows to calculate the probability of occurrence of given events, where the probability here expresses a degree of belief in the corresponding events. The center element of this framework is Bayes' theorem, a mathematical rule that describes the conditional probability of occurrence of an event, taking into account the prior experimental data one can have about such an event. Mathematically, Bayes' theorem can be expressed as follows:

$$P ( X \vert Y ) = \frac{P ( Y \vert X ) P ( X )}{P ( Y )} , \qquad ( 10 )$$

where P(X|Y) denotes the conditional probability of occurrence of event X given that event Y occurred, and P(X) denotes the total probability of event X.

The framework of Bayesian statistics is based on Bayes' theorem, which is used to continuously compute and update probabilities of events as new evidence is presented and knowledge about the events is updated. After combining prior experimental data with observed evidence, one can thus perform predictive inference in the Bayesian statistical framework. Examples of predictions that can be made using a Bayesian statistical approach include predicting the event that is the most likely to occur in the future, predicting the probability at which a specific event may occur in the future, predicting confidence intervals around the occurrence of particular events, and so on.

To perform predictive inference in the Bayesian framework, one needs to compute the posterior distribution, which combines prior experimental data with the observed experimental data using Bayes' theorem. Let x denote a generic data point (or event) and θ denote the parameters of the data point's distribution, such that x˜P(x|θ). Moreover, let represent the hyperparameter of the parameter distribution, such that θ˜P(θ|α).

Furthermore, let X denote the sample, which is the set of N observed data points {x₁, . . . , x_{N}}. Finally, let x̅ represents a new data point whose probability distribution is to be predicted. It is understood that in the general case, x, x̅, θ, α correspond to vectors of values to account for the dimensionality of the problem.

The prior distribution, denoted P(θ|α), is an estimation of the distribution of the parameters before any sample is observed. It might be determined using, but not limited to, intuition or beliefs about the process, knowledge gathered from experts in the field, prior data gathered from previous manifestations of similar processes, or any combination thereof. The likelihood distribution, or sampling distribution, is denoted P(X|θ, α) and represents the distribution of observed data conditional on its parameters. The evidence distribution, or distribution of the observed data marginalized over the parameters, is given by:

P(X|α)=∫P(X|θ,α)P(θ|α)dθ. (11)

Once these values are known, the posterior distribution, namely the distribution of parameters conditional to the observed data, can be determined using Bayes' theorem:

$$P ( θ \vert X , α ) = \frac{P ( X \vert θ , α ) P ( θ \vert α )}{P ( X \vert α )} . \qquad ( 12 )$$

Solving this equation generally involves using computational methods of the Markov Chain Monte Carlo family, such as the Metropolis algorithm or the No-U-Turn-Sampler. Once the posterior distribution is evaluated, predictions can be made using the posterior predictive distribution, which is given by:

P(x̅|X, α)=∫P(x̅|θ)P(θ|X, α)dθ. (13)

To configure the growth prediction engine to operate using the Bayesian statistical framework, it is assumed that the distribution of the growth indicator quantity (here body weight is used, but it is understood that any other growth indicator quantities could equivalently be used) in the organisms of the population is described by a specific class of distribution. In practice, the Normal distribution or the Log-Normal distribution can be used when the growth indicator quantity is the body weight, but other distributions may be more suited to other growth indicator quantities.

Next, it is also assumed that the mean of the weight distribution ω̅(t) evolves over time following a nonlinear growth model, such as the Von Bertalanffy model described earlier in Equation (6). It is understood that other nonlinear growth models could be used, such as the Gompertz model. Contrary to Equation (6), where each parameter of the nonlinear growth model is considered to have a fixed value, it is now supposed that each parameter is described by an underlying probability distribution. For example, one might assume that the asymptotic body weight parameter in Equation (6) follows a Gamma distribution, e.g., ω̅_{∞}˜Γ(μ_{ω̅}_{_{˜}}, σ_{ω̅}_{_{∞}}) of mean μ_{ω̅}_{_{∞}} and standard deviation σ_{ω̅}_{_{∞}}. It may also be assumed in a hierarchical fashion that μ_{ω̅}_{_{∞}} and σ_{ω̅}_{_{∞}} follow also their own probability distribution, and so on.

Furthermore, it is also assumed that the coefficient of variation (standard deviation over the mean) of the weight distribution evolves in time according to another model. A model that works well in practice is:

$${cv}_{\overline{ω} ( t )} = a + b \frac{d \overline{ω} ( t )}{dt} , \qquad ( 14 )$$

where a and b are parameters with their own probability distribution consisting of other hyperparameters, for example α˜Γ(μ_{α}, σ_{α}). This is introduced as a simplification from the assumption that the population consists of organisms with their own individual growth parameters, whereas growth is described at the population level.

The prior experimental data is established by specifying beliefs about all the parameters involved in the model. To take the example presented above, for the parameter this would imply specifying the prior beliefs on the possible probability distribution of μ_{ω̅}_{_{∞}} and σ_{ω̅}_{_{∞}} can take. As mentioned earlier, these prior beliefs may come from databases fueled by prior data points measurements and/or expert knowledge. It can also be advantageous to draw this prior experimental data using the monitored growth of other populations of organisms of the same species. Stronger or weaker priors can be given to each parameter, reflecting how strong the beliefs are about each.

The likelihood function is then specified using the assumption that the mean and coefficient of variation of body weight distribution of the organisms in the population follow the nonlinear models described above. Using the notation introduced in Example 1, assuming a sample that consists of a series of N observed values of the distribution of individual values of the body weight {wₖ}ᵢ, with k=1, . . . , Mᵢ and i=1, . . . , N, the likelihood can thus be described by a density function which mean and coefficient of variation evolve over time according to the equations above. Normal density or Huber density, which is less sensitive to outliers, have been proven to work well in practice.

Using the prior experimental data, as well as the likelihood function, one can solve for the posterior distribution as described above, and obtain the posterior predictive distribution. From there, the growth prediction engine can perform precise predictions regarding the future weight of the organisms in the population, taking into account all the prior experimental data and new experimentally measured values of the weight distribution for the population under interest.

Moreover, as more observed data is gathered over time, for example when another measurement of the body weight distribution is performed at a later moment in time, the posterior distribution can be recalculated, allowing to refine the predictive posterior distribution and make better predictions. Performing this method in an iterative manner over time as the population of organisms grows can thus allow satisfactory prediction to be computed.

Examples of values that can be predicted using the Bayesian framework include, but are not limited to, the future average weight, median weight, modal weight, weight coefficient of variation of the weight distribution of the population, the future weight distribution function of the population itself, as well as confidence intervals around all of those predicted values. Examples of such confidence intervals are shown in FIG. 4.

Finally, since the Bayesian framework allows to incorporate a lot of prior experimental data in the predictive posterior distribution, it allows generating more precise predictions with fewer observed samples. When using very strong prior experimental data, it is for example possible to generate precise growth predictions with as few as a single observed sample.

An example of prior experimental data is shown at 351 in FIG. 3. It is envisaged that such prior experimental data can be provided in the form of look-up table(s) showing one or more growth indication quantities as function of time for one or more organism species, functions indicating the evolution of one or more growth indication quantities over time for one or more organism species or any other suitable format.

In some embodiments, growth of a specific population of Ecuadorian whiteleg shrimps is to be assessed. In these embodiments, one can use the modified Von Bertalanffy model described above with reference to Equation (6) with the Bayesian approach. Among the parameters to be determined, this model features an asymptotic weight parameter ω_{∞} which represents the final weight at which the organisms are expected to grow. In a first embodiment, the prior experimental data can be provided in the form of a reference value stored on an accessible database and which pertains to the asymptotic weight parameter ω_{∞}. For example, the reference value could be a guess that a shrimp is probably going to grow up to at least 1 g, but no more than 1 kg. Mathematically, this could be expressed by a prior distribution for the parameter ω_{∞} being uniform over the range 1 g to 1 kg, for instance. That's still a wide range of values, yet it tells the model that is likely to be in the 1 g-1 kg range. In a second embodiment, the prior experimental data could be provided in the form of accurate prior experimental data originating from an input device, such as a keyboard, which can be used by a shrimp expert to input an expected asymptotic weight parameter ω_{∞} for the Ecuadorian whiteleg shrimps. In a third embodiment, the prior experimental data could be pulled from one or more databases factoring in different biological, environmental and/or industrial factors characteristic of Ecuador. For instance, the databases may indicate that the asymptotic weight parameter ω_{∞} of Ecuadorian whiteleg shrimps can vary between 20 g and 50 g at maturity. This would provide a more specific range for the parameter ω_{∞}. Furthermore, previous experimental data gathered on populations of whiteleg shrimps in Ecuador could be studied, and computed that on average, they grow up to 31.2 g with a standard deviation of +/−10.7 g; this prior experimental data could be modeled by a Gaussian prior distribution of mean 31.2 g and standard deviation of 10.7 g, for instance. This other, more quantitative, form of prior experimental data could also be injected in the Bayesian approach at the start of the modelling process.

### EXAMPLE 4

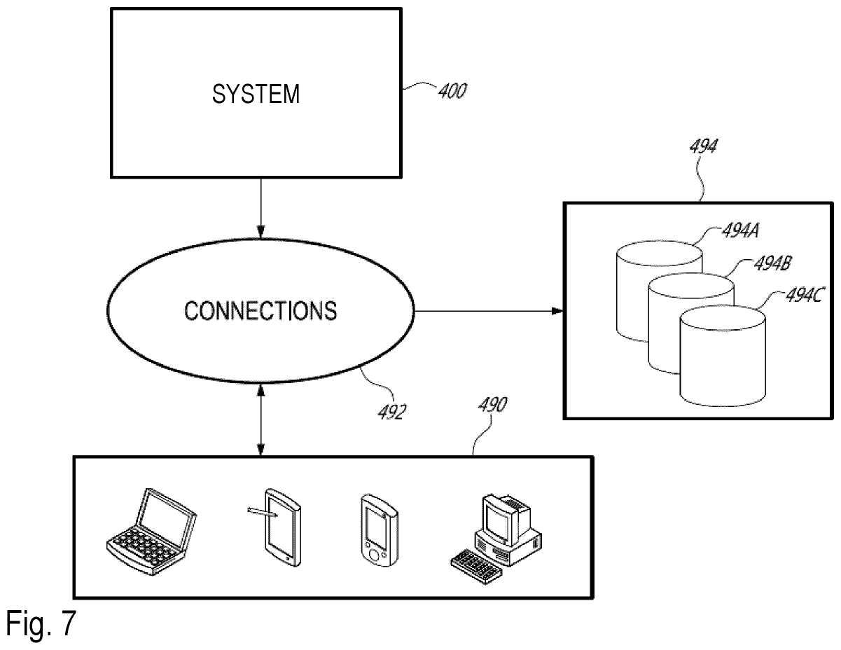

FIG. 7 shows an example of a system 400 for predicting growth of a population of organisms, in accordance with an embodiment. As depicted, the system 400 has a camera 410 having a field of view 420 orientable towards the population 404 of organisms 402 and which is configured for acquiring an image of the one or more organisms 402 of the population 404. The system 400 has a controller 412 having a memory on which are stored the software program such as the one described with reference to FIG. 3. In this particular embodiment, the system 400 has a structure 408, or frame, to which the camera 410 and the controller 412 are mounted. More specifically, the structure 408 is provided in the form of a mobile device, such as a smart phone or an electronic tablet.

Accordingly, in this embodiment, the system 400 can be handled by a user to acquire an image 428 of the population 404, after which the acquired image 428 can be processed by the controller 412 to determine one or more values of a growth indication quantity concerning the organisms 402 of the population 404 on the go. As can be noticed, the sample of organisms 402 that is imaged in this embodiment is provided in the form of a large portion, if not the entirety, of the population 404 of organisms 402. The so-determined values of the growth indication quantity can thus be used to determine the predicted values of the growth indication quantity using the growth prediction engine.

In contrast with the embodiment of FIG. 1, which provided a predetermined, constant distance d between the camera and the sample, the manoeuvrability of the system 400 may cause challenges in suitably referencing the population 404 with respect to the system 400. Accordingly, at least one reference object 491 may be positioned in the field of view 420 of the camera 410 proximate to the population 404 so that a sample referencing engine being stored on the memory of the controller 412 can localize a position and an orientation of the population 404 relative to the camera 410 based on the accessed image 428 including the reference object(s) 491. In some embodiments, the sample referencing engine is trained using either supervised learning or unsupervised learning. As such, the growth indication quantity determination engine can factor in the position and the orientation of the sample relative to the camera 410, which can impact the determination of the growth indication quantity. As can be understood, the sample referencing engine can be trained using training images showing organism representations which are associated to different position and orientation truth values. An example of such sample referencing engine is shown at 347 in the software program 300 of FIG. 3.

Examples of such reference objects 491 can include, but not limited to, a container having known dimensions receiving the organisms, a geometric object having known dimensions (e.g., a square marker of particular color/pattern), a known arrangement of reference objects, where the relative distance(s) between the reference objects is known, and/or any other suitable reference object(s).

Referring now to FIG. 7, in some embodiments, the system 400 may be accessible remotely from any one of a plurality of external devices 490 over connections 492. External devices 490 may be any one of a desktop, a laptop, a tablet, a smartphone, and the like. External devices 490 may have a software application such as software application 300 of FIG. 3 provided wholly or partly thereon as a downloaded software application, a firmware application, or a combination thereof, for accessing the system 400. Alternatively, external devices 490 may access the system 400 via a web application, accessible through any type of Web browser.

The connections 492 may comprise wire-based technology, such as electrical wires or cables, and/or optical fibers. The connections 492 may also be wireless, such as RF, infrared, Wi-Fi, Bluetooth, and others. The connections 492 may therefore comprise a network, such as the Internet, the Public Switch Telephone Network (PSTN), a cellular network, or others known to those skilled in the art. Communication over the network may occur using any known communication protocols that enable external devices 490 within a computer network to exchange information. The Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol).

In some embodiments, the software program 300 of FIG. 3 is provided at least in part on any one of external devices 490. For example, the software program 300 may be configured as a first portion provided in the system 400 (or the system 100) to obtain and transmit the inputs such as the image and/or the detection data to a second portion, provided on one of the external devices 490. The second portion may be configured to receive the inputs such as the image and/or the detection data, and perform the steps carried by the growth indication quantity determination engine on one of the external devices 490. Alternatively, the software program 300 is provided entirely on any one of the external devices 490 and is configured to receive an image from a remote system such as the one described with reference to FIG. 1. Also alternatively, the system 400 can be configured to transmit, via connections 492, one or more of inputs such as the image, data concerning the growth indication quantity and the like. Other embodiments may also apply.

One or more databases 494, such as databases 494A, 494B and/or 494C may be provided locally on any one of the system 100 and the external devices 490, or may be provided separately therefrom (as illustrated). In the case of a remote access to the databases 494, access may occur via the connections 492 taking the form of any type of network, as indicated above. The various databases 494 described herein may be provided as collections of data or information organized for rapid search and retrieval by a computer. The databases 494 may be structured to facilitate storage, retrieval, modification, and deletion of data in conjunction with various data-processing operations. The databases 494 may be any organization of data on a data storage medium, such as one or more servers. The databases 494 illustratively have stored therein raw data representing training images and associated truth data.

Each computer program described herein may be implemented in a high level procedural or object oriented programming or scripting language, or a combination thereof, to communicate with a computer system. Alternatively, the programs may be implemented in assembly or machine language. The language may be a compiled or interpreted language. Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

As can be understood, the examples described above and illustrated are intended to be exemplary only. For instance, while the above-described embodiments are based on values of the same growth indication quantity, it is appreciated that the growth prediction engine of the present disclosure can use other parameters to generate the predicted values. Example of such parameters include, but are not limited to, species of the organisms of the population, date of hatch, typical survival rates, typical pond density, typical feeding rates, typical water quality metrics such as water temperature, water salinity, water pH, weather data, previous partial harvests data, animal stocking density, etc. Moreover, the sample can include one or more organisms in a liquid medium in some embodiments whereas the sample can include only the one or more organisms in some other embodiments, lacking any liquid medium. Also, although a nonlinear fitting has been described with reference to Example 1, it is envisaged that linear fitting can be used in at least some embodiments as well. The scope is indicated by the appended claims.

1. A system for predicting growth of a population of organisms, using at least a first value of a growth indicator quantity being associated to a first sample of said population at a first moment in time, the system comprising:
a container;
a structure facing the container and having a camera with a field of view orientable towards a second sample of said population of organisms, and being configured for acquiring an image of said second sample at a second moment in time; and
a controller having a memory and a processor configured to perform the steps of:
accessing said image;
using a growth indication quantity determination engine being stored on said memory and said accessed image, determining at least a second value of the growth indication quantity being associated to the second sample of said population; and
using a growth prediction engine, and based on at least the first and second values of the growth indication quantity, determining at least a predicted value of said growth indication quantity for said population at least at a subsequent moment in time.

2. The system of claim 1 further comprising a visual indicator visually indicating said at least a predicted value of said growth indication quantity.

3. The system of claim 1 wherein said determining at least a predicted value of said growth indication quantity includes determining predicted values of said growth indication quantity for a plurality of subsequent moments in time.

4. The system of claim 1 further comprising receiving at least another value of the growth indication quantity of at least another sample of said population of organisms at least at another moment in time, and, using the growth prediction engine, determining at least another predicted value of said growth indication quantity for said population at least at another subsequent moment in time further based on the at least another value of the growth indication quantity.

5. The system of claim 1 wherein said determining at least a predicted value of said growth indication quantity includes using a nonlinear growth curve to obtain said predicted values of the growth indication quantity.

6. The system of claim 5 wherein said using a nonlinear growth curve includes fitting the nonlinear growth curve to the first and second values of the growth indication quantity based on an expected asymptotic value of a size of the organisms and on a rate of change of values of said size being function of said asymptotic value.

7. The system of claim 1 wherein said determining at least a second value includes determining an average value of a plurality of individual values associated to respective organisms of the second sample as shown in the accessed image.

8. The system of claim 1 wherein said determining at least a second value includes determining a plurality of individual values associated to respective organisms of the second sample as shown in the accessed image.

9. The system of claim 7 wherein said determining said plurality of individual values includes:
using the growth indication quantity determination engine,
detecting one or more organism representations in one or more corresponding portions of the accessed image and generating detection data concerning the one or more detected organism representations; and
determining said individual values of the growth indication quantity associated to the one or more detected organism representations based on the detection data.

10. The system of claim 1 wherein said growth indication quantity is indicative of a body weight.

11. The system of claim 1 wherein said predicted value of said growth prediction engine is at least one of a predicted average body weight and a body weight distribution function of said population of organisms.

12. The system of claim 1 further comprising a communication unit communicatively coupled to said controller, said communication unit being configured for receiving said first value of said growth indicator quantity.

13. A method for predicting growth of a population of organisms, the method comprising:
receiving a first sample of said population of organisms into a container at a first moment in time;
imaging said first sample of said population to obtain a first image;
using a growth indication quantity determination engine and said first image, determining at least a first value of the growth indication quantity being associated to the first sample of said population;
receiving a second sample of said population of organisms into the container at a subsequent, second moment in time;
imaging said second sample of said population to obtain a second image;
using the growth indication quantity determination engine and said second image, determining at least a second value of the growth indication quantity being associated to the second sample of said population; and
using a growth prediction engine, and based on at least the first and second values of the growth indication quantity, determining at least a predicted value of said growth indication quantity for said population at least at a subsequent moment in time.

14. The method of claim 13 further comprising visual indicating said at least a predicted value of said growth indication quantity.

15. The method of claim 13 wherein said determining at least a predicted value of said growth indication quantity includes determining predicted values of said growth indication quantity for a plurality of subsequent moments in time.

16. The method of claim 15 further comprising receiving at least another value of the growth indication quantity of at least another sample of said population of organisms at least at another moment in time, and, using the growth prediction engine, determining at least another predicted value of said growth indication quantity for said population at least at another subsequent moment in time further based on the at least another value of the growth indication quantity.

17. The method of claim 13 wherein said determining at least a predicted value of said growth indication quantity includes using a nonlinear growth curve to obtain said predicted values of the growth indication quantity.

18. The method of claim 17 wherein said using a nonlinear growth curve includes fitting the nonlinear growth curve to the first and second values of the growth indication quantity based on an expected asymptotic value of a size of the organisms and on a rate of change of values of said size being function of said asymptotic value.

19-23. (canceled)

24. A method for predicting growth of a population of organisms, the method comprising:
receiving a first sample of said population of organisms into a container at a first moment in time;
imaging said first sample of said population to obtain a first image;
using a growth indication quantity determination engine and said first image, determining at least a first value of the growth indication quantity being associated to the first sample of said population; and
using a growth prediction engine, accessing prior experimental data pertaining to a species of said organisms, and determining at least a predicted value of said growth indication quantity for said population at least at a subsequent moment in time based on said prior experimental data, said first value of the growth indication quantity and said first moment in time.

25. The method of claim 24 wherein said prior experimental data includes a look-up table showing a plurality of growth indication quantities for different moments in time for said species of said organisms.

26. (canceled)
